(19) United States
(12) Patent Application Publication
(10) Pub. No.: US 2013/0326567 A1
(43) Pub. Date: Dec. 5, 2013

(54) Real Time Broadcasting Method Using Digital Living Network Alliance (DLNA) Between Set-Top Boxes

(71) Applicant: Sung Jin Park, Anyang Si (KR)

(72) Inventor: Sung Jin Park, Anyang Si (KR)

(73) Assignee: Innopia Technologies, Inc., Seongnam-si (KR)

(21) Appl. No.: 13/622,593

(22) Filed: Sep. 19, 2012

(30) Foreign Application Priority Data
May 29, 2012 (KR) 10-2012-0056591

(51) Int. Cl. H04N 21/60; H04N 21/27

(52) U.S. Cl. 725/82; 725/85

(57) ABSTRACT

A real time broadcasting method between set-top boxes using a Digital Living Network Alliance (DLNA) is provided. The real time broadcasting method may include receiving a broadcast stream, by a first set-top box including a tuner, and sharing the received broadcast stream using the DLNA so as to enable the broadcast to be viewed through a second set-top box in which a tuner is absent.

### CROSS-REFERENCE TO RELATED APPLICATION

This application claims the benefit of Korean Patent Application No. 10-2012-0056591, filed on May 29, 2012, in the Korean Intellectual Property Office, the disclosure of which is incorporated herein by reference.

### BACKGROUND OF THE INVENTION

1. Field of the Invention

The present invention relates to a real time broadcasting method using a Digital Living Network Alliance (DLNA) between set-top boxes, and more particularly, to a method of transmitting a broadcast in real time between set-top boxes using the DLAN.

2. Description of Related Art

A set-top box refers to an apparatus that may convert data received from an external device to be displayed on a television (TV). Generally, a tuner may be provided in the set-top box to receive a broadcast signal.

The tuner provided in the set-top box may select a broadcast channel desired by a user by tuning a broadcasting frequency or a radio wave transmitted from a broadcasting station, thereby enabling a broadcast program desired by the user to be output through the TV connected to the set-top box.

Accordingly, when a plurality of TVs is present in a single home, a set-top box is to be connected to each TV in order to view broadcast programs on each of the plurality of TVs.

However, a relatively great cost may be required to purchase set-top boxes corresponding to a number of TVs. In addition, although a plurality of set-top boxes are purchased, power consumption in the home may increase due to an amount of power used by each of the plurality of set-top boxes.

Accordingly, there is a desire for a method of reducing a cost when broadcast programs are viewed on a plurality of TVs in a single home.

### BRIEF SUMMARY OF THE INVENTION

An aspect of the present invention provides a real time broadcasting method using a Digital Living Network Alliance (DLNA) between set-top boxes, the method that may reduce a cost required when broadcast programs are viewed on a plurality of televisions (TVs).

According to an aspect of the present invention, there is provided a method of transmitting a broadcast in real time, the method including receiving a broadcast stream, by a first set-top box including a tuner, and sharing the received broadcast stream using a DLNA so as to enable the broadcast to be viewed through a second set-top box in which a tuner is absent.

The method may further include receiving, by the first set-top box, information about a broadcast channel selected by a user from the second set-top box. Here, the receiving of the broadcast stream may include receiving a broadcast stream of a corresponding broadcast channel, using the tuner of the first set-top box based on the received information about the broadcast channel.

The method may further include storing the received broadcast stream.

The method may further include transmitting the shared broadcast stream to the second set-top box through a Digital Media Server (DMS) included in the first set-top box, in response to a request from the second set-top box.

The method may further include playing the transmitted broadcast stream through a display connected to the second set-top box, by a Digital Media Player (DMP) included in the second set-top box.

### Effect of the Invention

According to an embodiment of the present invention, a broadcast may be viewed through a set-top box in which a tuner is absent, by sharing a broadcast stream received by a set-top box including a tuner with the set-top box in which the tuner is absent, using a Digital Living Network Alliance (DLNA). Accordingly, when broadcast programs are desired to be viewed on a plurality of televisions (TVs), a cost to be used for purchasing set-top boxes in which tuners are absent may be reduced.

In addition, since a tuner is absent in a set-top box, an amount of power used by the tuner may be reduced and thus, power consumption of the set-top box may be reduced.

### BRIEF DESCRIPTION OF THE SEVERAL VIEWS OF THE DRAWINGS

These and/or other aspects, features, and advantages of the invention will become apparent and more readily appreciated from the following description of exemplary embodiments, taken in conjunction with the accompanying drawings of which:

FIG. 1 is a flowchart illustrating a method of transmitting a broadcast in real time between set-top boxes using a Digital Living Network Alliance (DLNA) according to an embodiment of the present invention;

FIG. 2 is a diagram illustrating a DLNA according to an embodiment of the present invention; and

FIG. 3 is a diagram illustrating a structure of a set-top box, and a process of transmitting a broadcast between set-top boxes using a DLNA according to an embodiment of the present invention.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

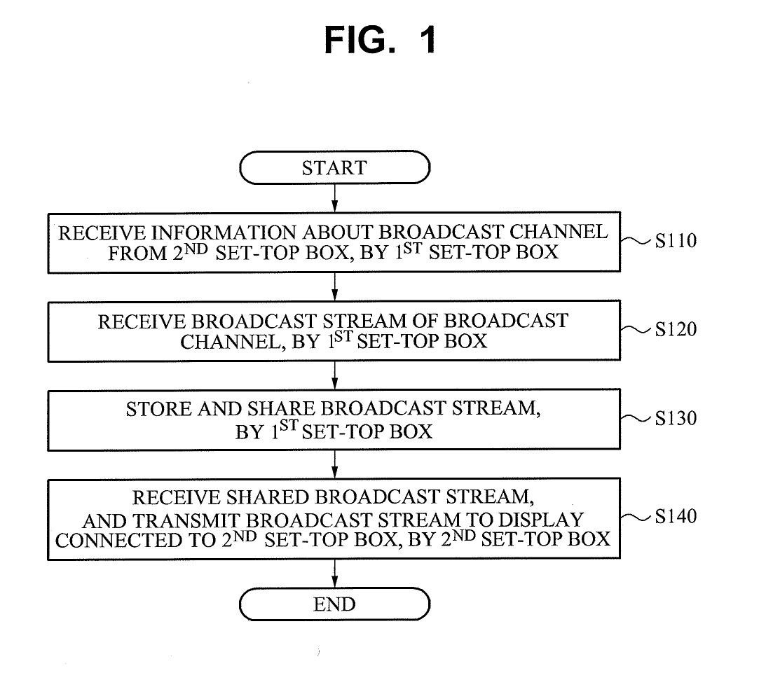

FIG. 1 is a flowchart illustrating a method of transmitting a broadcast in real time between set-top boxes using a Digital Living Network Alliance (DLNA) according to an embodiment of the present invention.

In the real time broadcasting method between the set-top boxes using the DLNA, it may be assumed that a plurality of televisions (TVs) is present in a single home, and a plurality of set-top boxes are required since broadcast programs are desired to be viewed on each of the plurality of TVs, and the like. In order to reduce a cost to be used to purchase the set-top boxes, a cost of power consumption of the set-top boxes, and the like, a set-top box including a tuner, hereinafter referred to as a first set-top box, may be connected to a display being a reference, for example, a TV, and a broadcast signal received by the first set-top box from a broadcasting station may be shared so that a plurality of set-top boxes in which tuners are absent, hereinafter referred to as second set-top boxes, may receive the broadcast signal.

In this instance, a plurality of tuners may be included in the first set-top box, and each of the plurality of tuners may enable a broadcast program of a broadcast channel selected by the user through the first set-top box to be output through a display connected to the first set-top box, and may receive broadcast streams of other broadcast channels selected through the plurality of second set-top boxes.

Hereinafter, the method of transmitting the broadcast in real time between set-top boxes using the DLNA will be described in detail with reference to FIG. 1.

Referring to FIG. 1, in operation S110, a first set-top box may receive information about a broadcast channel desired to be viewed by a user from a second set-top box. In operation S120, the first set-top box may receive a broadcast stream by selecting the corresponding broadcast channel using a tuner included in the first set-top box, based on the received information about the broadcast channel.

In operation 5130, the first set-top box may store the received broadcast stream, and may share the stored broadcast stream using the DLNA so as to enable a corresponding broadcast to be viewed by the user through the second set-top box.

When the shared broadcast stream is requested by the second set-top box, the first set-top box may transmit the stored broadcast stream to the second set-top box, using a Digital Media Server (DMS) included in the first set-top box.

In operation S140, the second set-top box may transmit the broadcast stream received from the first set-top box to a display connected to the second set-top box, using a Digital Media Player (DMP) included in the second set-top box, thereby enabling the broadcast program desired by the user to be played in real time on the display. Here, the display connected to the second set-top box may include, for example, a TV, a monitor, a personal computer (PC), a table PC, a smart phone, and the like.

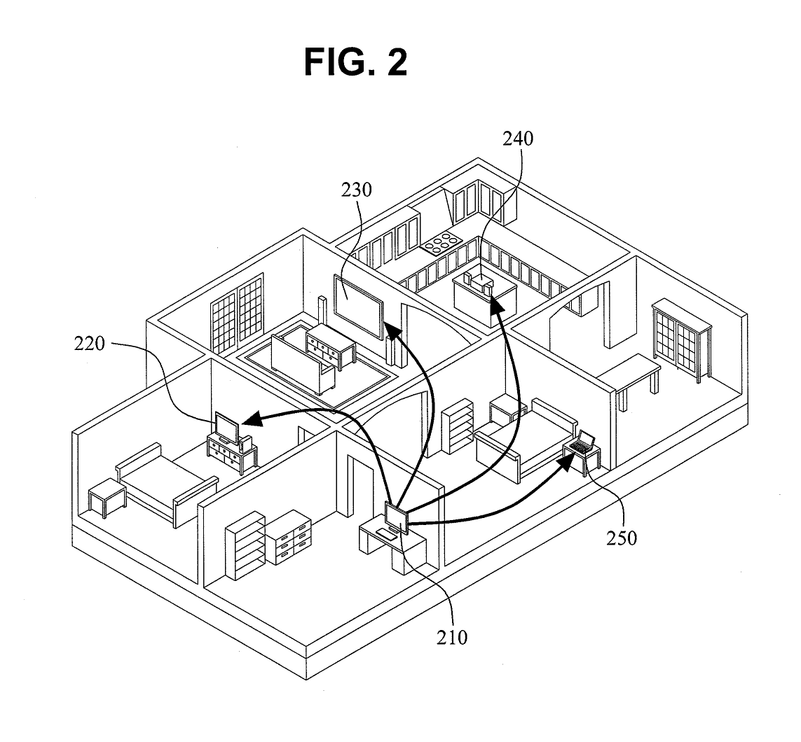

FIG. 2 is a diagram illustrating a DLNA according to an embodiment of the present invention.

The DLNA may enable a variety of contents, for example, music, photos, videos, and the like, to be freely transmitted and shared via a home network, based on industrial standards which are widely used by manufacturers manufacturing home appliances, PCs, wireless devices, and the like. Here, the industrial standards may include, for example, Internet Protocol (IP), Hyper Text Transfer Protocol (HTTP), Universal Plug and Play (UPnP), Wireless Fidelity (Wi-Fi), and the like.

As shown in FIG. 2, a PC 210 including a DMS function of the DLNA may use a DMS to share contents stored in the PC 210 or played in the PC 210 with other devices existing on a home network via a wireless communication network, for example, Wi-Fi, Ethernet, and the like, thereby enabling the contents of the PC 210 to be played through DMPs included in a TV 220 installed in a bedroom, a TV 230 installed in a living room, an audio system 240 installed in a kitchen, and the like, or to be played on a portable electronic device 250, for example, a smart phone, a tablet PC, a personal digital assistant (PDA), and the like.

The DLNA may include a Digital Media Server (DMS), a Digital Media Player (DMP), a Digital Media Renderer (DMR), a Digital Media Controller (DMC), a Digital Media Printer (DMPr), and the like. A mobile device may include a Mobile Digital Media Server (M-DMS), a Mobile Digital Media Player (M-DMP), a Mobile Digital Media Uploader (M-DMU), a Mobile Digital Media Downloader (M-DMD), a Mobile Digital Media Controller (M-DMC), and the like.

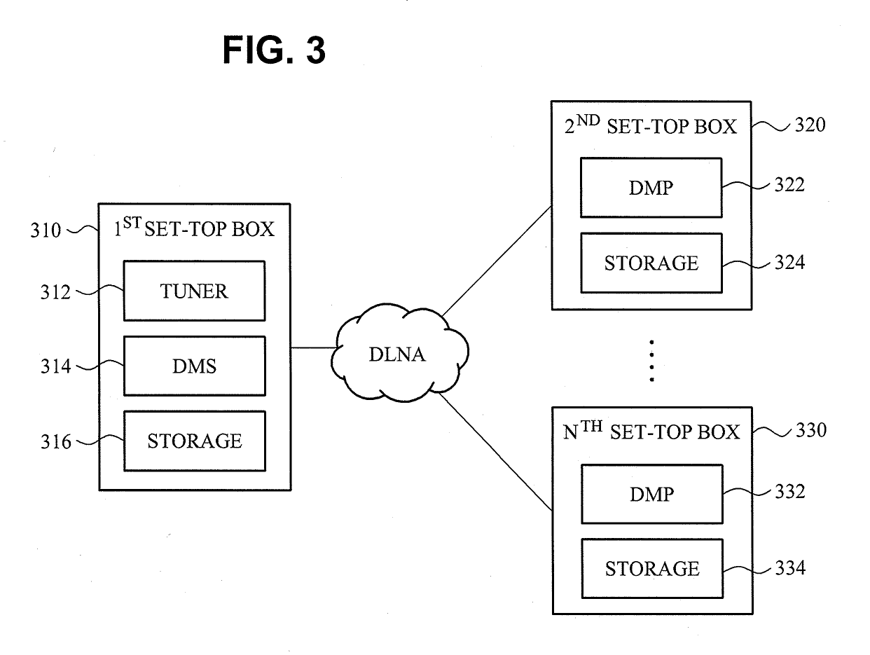

FIG. 3 is a diagram illustrating a structure of a set-top box, and a process of transmitting a broadcast between set-top boxes using a DLNA according to an embodiment of the present invention.

Referring to FIG. 3, a first set-top box 310 may be connected to a display being a reference on a home network, for example, a TV installed in a living room. A second set-top box 320 or an n^{th} set-top box 330 may be connected to another display existing on the home network, for example, a TV installed in a bedroom, a kitchen, or the like.

As shown in FIG. 3, the first set-top box 310 connected to the display being the reference may include a tuner 312, a DMS 314, and a storage 316. The second set-top box 320 connected to the first set-top box 310 via the home network may include a DMP 322, and a storage 324. The n^{th} set-top box 330 connected to the first set-top box 310 via the home network may include a DMP 332, and a storage 334.

Although not shown in FIG. 3, each of the first set-top box 310, the second set-top box 320, and the n^{th} set-top box 330 may include a modulator, a decoder, a microprocessor, and the like.

The modulator may modulate and separate a signal of a broadcast channel selected by a tuner into an original data signal, a video signal, and/or an audio signal, and provide the separated signals to the decoder.

The decoder may decode the separated signals using decoders for each signal, for example, a data decoder, a video decoder, and an audio decoder, respectively, and may transmit the decoded signals to a display so as to enable a broadcast program to be viewed by a user.

Although the first set-top box 310 includes the DMS 314, the second set-top box 320 includes the DMP 322, and the n^{th} set-top box 330 includes the DMP 332, each of the first set-top box 310, the second set-top box 320, and the n^{th} set-top box 330 may include both a DMS and a DMP, as necessary, such that contents stored in the storage 316 of the first set-top box 310, the storage 324 of the second set-top box 324, and the storage 334 of the n^{th} set-top box 330 may be shared.

In order to transmit a broadcast in real time between the first set-top box 310, and the second set-top box 320 or the n^{th} set-top box 330, broadcast storage functions of the first set-top box 310, the second set-top box 320, and the n^{th} set-top box 330, and the DLNA may be used.

The tuner 312 included in the first set-top box 310 may receive a stream of a broadcast program of a broadcast channel selected by the user through the first set-top box 310, thereby enabling the received broadcast program to be output through a display connected to the first set-top box 310. In addition, the tuner 312 may receive a stream of a broadcast channel selected by the user through the second set-top box 320 or the n^{th} set-top box 330, based on information about the broadcast channel received from the second set-top box 320 or the n^{th} set-top box 330.

The first set-top box 310 having received the stream of the broadcast channel selected through the second set-top box 320 or the n^{th} set-top box 330 may store the received broadcast stream in the storage 316 so as to enable the received broadcast program to be viewed through a display connected to the second set-top box 320 or the n^{th} set-top box 330.

The DMS 314 of the first set-top box 310 may share the broadcast stream stored in the storage 316 with the second set-top box 320 or the nth set-top box 330 connected to the home network using the DLNA.

When the first set-top box 310 receives a request for the shared broadcast stream from the second set-top box 320 or the n^{th} set-top box 330, the DMS 314 included in the first set-top box 310 may transmit the broadcast stream stored in the storage 316 to the second set-top box 320 or the n^{th} set-top box 330.

The second set-top box 320 or the n^{th} set-top box 330 having received the broadcast stream transmitted from the first set-top box 310 may transmit the received broadcast stream to a display connected to the second set-top box 320 or the n^{th} set-top box 330, using the DMP 322 included in the second set-top box 320 or the DMP 332 included in the n^{th} set-top box 330, so as to enable a broadcast program, desired by the user, to be played in real time through a corresponding display. Here, the display connected to the second set-top box 320 or the n^{th} set-top box 330 may include a TV, a monitor, a PC, a table PC, a smart phone, and the like.

In a real time broadcasting method between set-top boxes using a DLNA according to an embodiment of the present invention, when a plurality of TVs is present in a single home and broadcast programs are desired to be viewed on each of the plurality of TVs, the broadcast programs desired by the user may be output to the plurality of TVs connected to respective set-top boxes, using a single set-top box including a tuner and a plurality of set-top boxes in which tuners are absent.

Accordingly, when broadcast programs are desired to be viewed on a plurality of TVs, a user may reduce a purchasing cost by purchasing only a single set-top box including a tuner, which is more expensive than a set-top box in which a tuner is absent.

In addition, in this instance, only a single tuner is present on a home network and thus, power consumption may be reduced when compared to a case in which a plurality of tuners is present.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of transmitting a broadcast in real time, the method comprising:
receiving a broadcast stream, by a first set-top box comprising a tuner; and
sharing the received broadcast stream using a Digital Living Network Alliance (DLNA) so as to enable the broadcast to be viewed through a second set-top box in which a tuner is absent.

2. The method of claim 1, further comprising:
receiving, by the first set-top box, information about a broadcast channel selected by a user from the second set-top box,
wherein the receiving of the broadcast stream comprises receiving a broadcast stream of a corresponding broadcast channel, using the tuner of the first set-top box based on the received information about the broadcast channel.

3. The method of claim 1, further comprising:
storing the received broadcast stream.

4. The method of claim 1, further comprising:
transmitting the shared broadcast stream to the second set-top box through a Digital Media Server (DMS) included in the first set-top box, in response to a request from the second set-top box.

5. The method of claim 1, further comprising:
playing the transmitted broadcast stream through a display connected to the second set-top box, by a Digital Media Player (DMP) included in the second set-top box.
